(19) United States
(12) Patent Application Publication
(10) Pub. No.: US 2021/0229447 A1
(43) Pub. Date: Jul. 29, 2021

(54) INK-JET PRINTING APPARATUS

(71) Applicant: CANON KABUSHIKI KAISHA, Tokyo (JP)

(72) Inventors: Shoki Takiguchi, Tokyo (JP); Hiroki Hayashi, Kanagawa (JP)

(21) Appl. No.: 17/145,060

(22) Filed: Jan. 8, 2021

(30) Foreign Application Priority Data
Jan. 27, 2020 (JP) 2020-011246

(51) Int. Cl. B41J 2/175

(52) U.S. Cl. CPC B41J 2/1752; B41J 2002/17573; B41J 2/17566; B41J 2/17553

(57) ABSTRACT

An ink-jet printing apparatus includes an ink-cartridge mounting unit to which an ink cartridge containing ink is to be mounted. The ink-cartridge mounting unit includes a cover. The ink cartridge is disposed inside the cover and in the ink-jet printing apparatus in such a way that the ink cartridge is mounted to the ink-cartridge mounting unit, and then the cover is closed from an open state. The ink contained in the ink cartridge can be seen from outside of the ink-jet printing apparatus in a state where the cover is closed.

### BACKGROUND

### Field

The present disclosure relates to ink-jet printing apparatuses.

### Description of the Related Art

An ink-jet printing apparatus includes a print head that performs printing by ejecting ink from an ejection port. The ink ejected from the print head lands on a recording medium, so that an image and so on are printed on the recording medium. An ink cartridge that contains ink is mounted to such an ink-jet printing apparatus. When the ink cartridge is mounted, the ink is supplied from the ink cartridge to the print head in the ink-jet printing apparatus. When the contained ink decreases, so that sufficient ink cannot be supplied, the ink cartridge is replaced with a new one.

An example of such an ink cartridge is an ink cartridge having a transparent outer wall, disclosed in Japanese Patent Laid-Open No. 2018-161870. The ink cartridge disclosed in Japanese Patent Laid-Open No. 2018-161870 allows the user to see the state of the ink contained in the ink cartridge through the outer wall. Thus, the user can easily check how much the ink cartridge contains ink only by looking at the ink cartridge from the outside.

Although the ink cartridge disclosed in Japanese Patent Laid-Open No. 2018-161870 allows the user to see the amount of ink contained in the ink container through the transparent outer wall of the ink cartridge, this is only when the ink cartridge is not mounted to the ink-jet printing apparatus. The ink cartridge is generally mounted into the ink-jet printing apparatus through an opened cover.

After the ink cartridge is mounted, the opened cover is closed again. Thus, when the ink cartridge is mounted in the ink-jet printing apparatus, the ink cartridge is disposed inside the cover and in the ink-jet printing apparatus, so that the user cannot see the ink cartridge from the outside of the ink-jet printing apparatus. In other words, even if the ink cartridge has a transparent outer wall as disclosed in Japanese Patent Laid-Open No. 2018-161870, the user cannot see the state of the ink container from the outside of the ink-jet printing apparatus.

### SUMMARY

According to an aspect of the present disclosure, an ink-jet printing apparatus includes an ink-cartridge mounting unit to which an ink cartridge containing ink is to be mounted, wherein the ink-cartridge mounting unit includes a cover, wherein the ink cartridge is disposed inside the cover and in the ink-jet printing apparatus in such a way that the ink cartridge is mounted to the ink-cartridge mounting unit, and then the cover is closed from an open state, and wherein the ink contained in the ink cartridge can be seen from outside of the ink-jet printing apparatus in a state where the cover is closed.

Further features of the present disclosure will become apparent from the following description of exemplary embodiments with reference to the attached drawings.

### BRIEF DESCRIPTION OF THE DRAWINGS

FIG. 1 is a perspective view of an ink-jet printing apparatus according to an embodiment of the present disclosure.

FIG. 2A is a perspective view of an ink cartridge according to an embodiment of the present disclosure.

FIG. 2B is a side view of the ink cartridge.

FIG. 3 is a diagram of the ink-jet printing apparatus from which a cover is removed.

FIG. 4A is a diagram illustrating an ink-cartridge mounting unit with a cover.

FIG. 4B is a diagram illustrating the ink-cartridge mounting unit in FIG. 4A without the cover.

FIG. 5A is a diagram illustrating an ink-cartridge mounting unit according to an embodiment of the present disclosure.

FIG. 5B is a diagram illustrating an ink-cartridge mounting unit according to an embodiment of the present disclosure.

FIG. 6A is a perspective view of an ink cartridge according to an embodiment of the present disclosure.

FIG. 6B is a perspective view of an ink cartridge according to an embodiment of the present disclosure.

### DESCRIPTION OF THE EMBODIMENTS

When the user cannot see the amount of ink contained in the ink cartridge, if including, for example, a residual-amount detection mechanism, the user cannot find that the amount of the ink has decreased to less than the necessary amount until printing with the ink cartridge cannot be performed. Even if the ink cartridge includes a residual-amount detection mechanism, if it is not functioning properly, the user cannot find out the decrease in the ink residual amount early. The amount of ink contained in the ink cartridge can be seen when the closed cover is opened, and the ink cartridge is taken out. However, this exerts a large load on the user. If the cover is opened during printing, the printing using the print head might be stopped.

The present disclosure provides an ink-jet printing apparatus that allows the user to easily find the amount of ink contained in an ink cartridge mounted in the ink-jet printing apparatus even with the cover closed. Referring to the drawings, embodiments of the present disclosure will be described hereinbelow. In the following description, components with the same function are given the same reference sign, and descriptions thereof may be omitted.

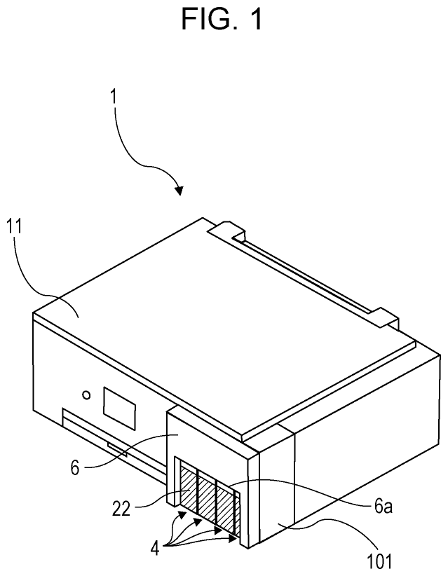

FIG. 1 is an example perspective view of an ink-jet printing apparatus according to an embodiment of the present disclosure. The ink-jet printing apparatus 1 is mainly formed of a casing 11. The ink-jet printing apparatus 1 includes an ink-cartridge mounting unit 101. The ink-cartridge mounting unit 101 includes a cover 6. The cover 6 is opened, and ink cartridges 4 are mounted to the ink-cartridge mounting unit 101. In FIG. 1, four ink cartridge 4 that contain cyan, magenta, yellow, and black inks are mounted to the ink-cartridge mounting unit 101.

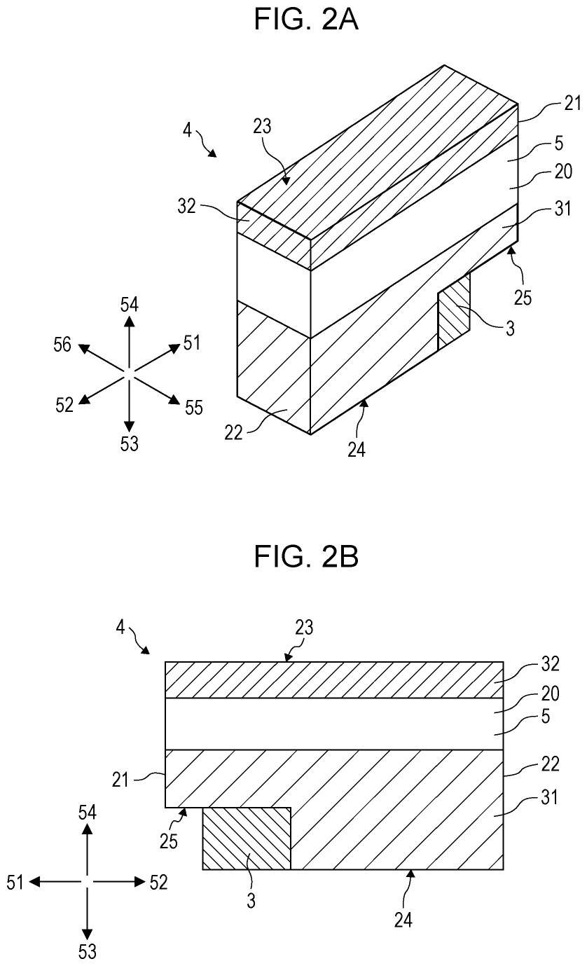

FIGS. 2A and 2B illustrate one of the ink cartridges 4 shown in FIG. 1 taken out and enlarged. FIG. 2A is a perspective view of the ink cartridge 4. FIG. 2B is a side view of the ink cartridge 4. The ink cartridge 4 has a front wall 21, a back wall 22, an upper wall 23, and lower walls (a first lower wall 24 and a second lower wall 25). The front wall 21 is a wall that is positioned forward in the mounting direction (the direction of arrow 51) when the ink cartridge 4 is mounted to the ink-jet printing apparatus 1 (ink-cartridge mounting unit 101). The back wall 22 is a wall that is opposite to the front wall 21 and backward in the mounting direction when the ink cartridge 4 is mounted to the ink-jet printing apparatus 1. When the ink cartridge 4 is dismounted from the ink-jet printing apparatus 1, the back wall 22 is positioned forward in the dismounting direction (the direction of arrow 52). In FIG. 1, the back walls 22 of the ink cartridges 4 are viewed at the ink-cartridge mounting unit 101. The upper wall 23 is a wall of the ink cartridge 4 disposed upward in the vertical direction (the direction of arrow 54), with the ink-jet printing apparatus 1 in use (the orientation shown in FIG. 1). The first lower wall 24 is a wall opposite to the upper wall 23 and disposed below in the vertical direction (the direction of arrow 53), with the ink-jet printing apparatus 1 in use. The lower wall is composed of the first lower wall 24 and the second lower wall 25 positioned off the first lower wall 24 in the direction of arrow 51 and higher than the first lower wall 24 in the vertical direction. An ink supply unit 3 is provided below the second lower wall 25 in the vertical direction. The front wall 21 and the back wall 22, and the upper wall 23 and the first and second lower walls 24 and 25 are each connected by side walls 20. The arrows 55 and 56 indicate the directions perpendicular to the arrows 51, 52, 53, and 54 and extending along the width of the ink cartridge 4.

As shown in FIGS. 2A and 2B, the upper wall 23 of the ink cartridge 4 is formed of a covering member 32. An ink chamber 5 that contains ink 31 is provided under the covering member 32 in the vertical direction. Multiple ink chambers 5 may be provided. The ink chamber 5 may contain a negative-pressure generating member that generates negative pressure. Examples of the negative-pressure generating member include an ink absorber and a spring. The ink 31 contained in the ink chamber 5 is supplied to a print head (not shown) of the ink-jet printing apparatus 1 from the ink supply unit 3 through a needle or the like (not shown). As shown in FIGS. 2A and 2B, the front of the ink supply unit 3 may be at a position back from the front wall 21 (in the direction of arrow 52).

The back wall 22 of the ink cartridge 4 is made of a transparent (colorless) member (for example, transparent plastic or glass). This allows the user to see the ink contained in the ink chamber 5 from the outside of the ink cartridge 4 through the back wall 22.

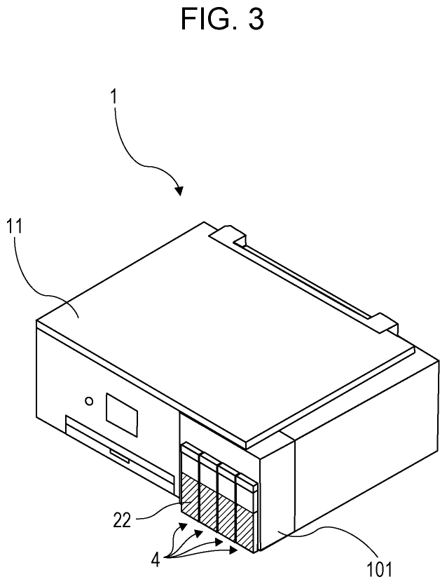

In the relate art, when such an ink cartridge 4 is mounted in the ink-jet printing apparatus 1 by opening the cover 6 and then closing the cover 6, the ink cartridge 4 is disposed at a position enclosed by the casing 11 and the cover 6, and cannot be seen from the outside of the ink-jet printing apparatus 1. In contrast, according to an embodiment of the present disclosure, even when the cover 6 is opened, the ink cartridge 4 is mounted in the ink-jet printing apparatus 1, and then the cover 6 is closed, the user can see at least part of the ink cartridge 4 from the outside of the ink-jet printing apparatus 1. In FIG. 1, part of the cover 6 is cut out (part of the rectangular cover 6 is cut out) at the ink-cartridge mounting unit 101 of the ink-jet printing apparatus 1. FIG. 3 illustrates a state in which the cover 6 of the ink-jet printing apparatus 1 in FIG. 1 is removed. As shown in FIG. 3, the ink cartridges 4 are mounted inside the cover 6. The cover 6 is opened when the ink cartridges 4 are to be mounted to the ink-cartridge mounting unit 101 and is closed after the ink cartridges 4 are mounted. Even when the cover 6 is closed, the back walls 22 of the ink cartridges 4 are seen through a cut-out portion (hereinafter referred to as “window”) 6a of the cover 6. The window 6a is hollow, and the ink cartridges 4 are exposed inside the window 6a. This allows the user to see the ink contained in the ink cartridge 4 from the outside of the ink-jet printing apparatus 1 through the space of the window 6a and the transparent back wall 22, with the ink cartridge 4 mounted to the ink-jet printing apparatus 1, and the cover 6 closed.

Here, the configuration in which the ink contained in the ink cartridge 4 is seen through the back wall 22 of the ink cartridge 4 after the cover 6 is closed have been described. Other examples include a configuration in which the ink can be seen through the front wall 21 and a configuration in which the ink can be seen through the upper wall 23, the first lower wall 24, or the second lower wall 25. However, the ink contained in the ink cartridge 4 may be seen through the back wall 22 in consideration of the mountability and the visibility of the ink cartridge 4. Not the whole of the back wall 22 needs to be seen from the outside of the ink-jet printing apparatus 1. As shown in FIG. 1, part of the back wall 22 may be seen from the outside of the ink-jet printing apparatus 1.

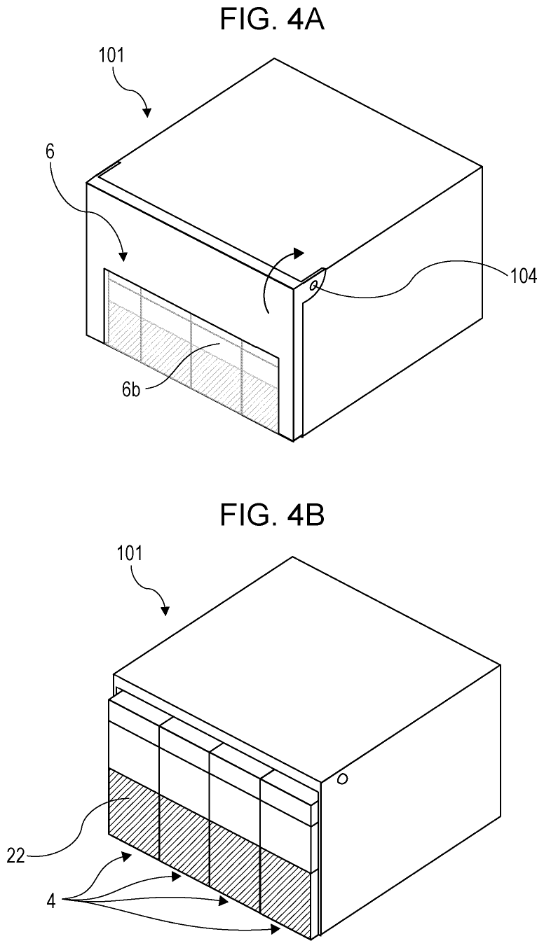

FIGS. 4A and 4B illustrate the ink-cartridge mounting unit 101 taken out from the ink-jet printing apparatus 1. FIG. 4A is a diagram illustrating the ink-cartridge mounting unit 101 with the cover 6. FIG. 4B is a diagram illustrating the ink-cartridge mounting unit 101 in FIG. 4A without the cover 6. The ink-cartridge mounting unit 101 shown in FIGS. 4A and 4B differs in the structure of the cover 6 from the ink-cartridge mounting unit 101 in FIG. 1. As shown in FIG. 4A, the cover 6 of the ink-cartridge mounting unit 101 is opened by rotating about a rotation shaft including protrusions 104. The direction of rotation of the cover 6 is illustrated in FIG. 4A. After the cover 6 is rotated to be opened, the ink cartridge 4 is mounted. After the ink cartridge 4 is mounted, the cover 6 is closed by being rotated in the direction opposite to the direction of rotation when the cover 6 is opened. The cover 6 has a window 6b made of a transparent member (glass or plastic). The back wall 22 of the ink cartridge 4 is seen inside the window 6b. In other words, the user can see the state of the ink chamber 5 from the outside of the ink-jet printing apparatus 1 through the transparent window 6b and the transparent back wall 22.

The cover 6 that is opened and closed by being rotated, as shown in FIG. 4A, is easy to open and close. Alternatively, the cover 6 may be opened and closed by being slid in the vertical direction or in the horizontal direction. The cover 6 can protect the ink cartridge 4 and prevent the evaporation of the ink contained in the ink cartridge 4. The configuration in which the cover 6 has the window 6b made of a transparent member, as illustrated in FIG. 4A, can protect the ink cartridge 4 and prevent the evaporation of the ink, as compared with the configuration in which the window 6a of the cover 6 is cut out, as illustrated in FIG. 1.

Having described the configuration in which the cover 6 has a window, the window does not need to be separate from the cover 6. In other words, the whole of the cover 6 may be made of a transparent member.

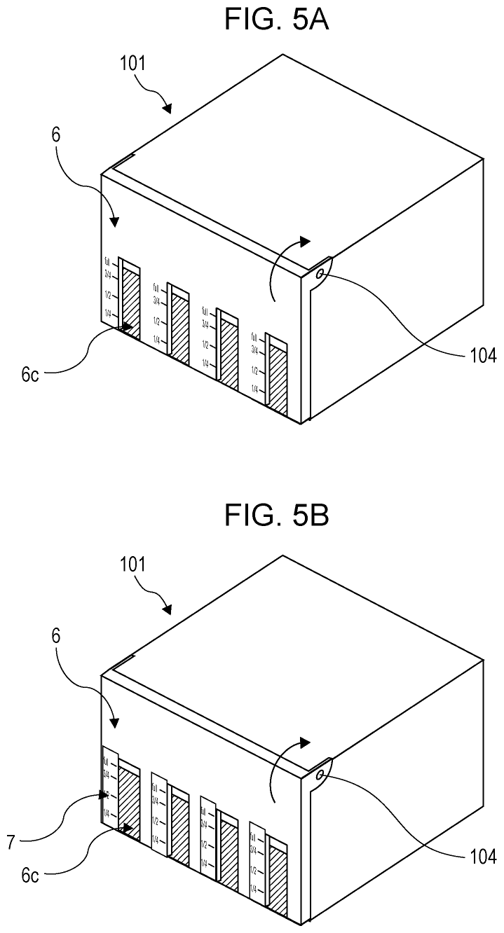

FIGS. 5A and 5B illustrate windows 6c which are obtained by putting a graded scale on the window (window 6b) of the cover 6 of the ink-cartridge mounting unit 101 shown in FIG. 4A. In FIG. 5A, the window 6c is made of a transparent member, on which a colored graded scale is put. This graduated scale allows the user to determine the amount of ink remaining in the ink cartridge 4 seen through the window 6c. In particular, the window 6c is not in direct contact with the ink, and is unlikely to get dirty. This allows the user to easily determine the amount of ink remaining in the ink cartridge 4. The graded scale put on the window 6c may be either multiple lines corresponding to the liquid surface, as shown in FIG. 5A, or identification symbols other than lines (for example, numeric characters or marks). In the ink-cartridge mounting unit 101 shown in FIG. 5B, a label 7 is bonded next to the window 6c with a graded scale. The label 7 is marked with identification symbols, such as numerical numbers, corresponding to the graded scale. This allows the user to see and determine the amount of ink remaining in the ink cartridge 4 more easily.

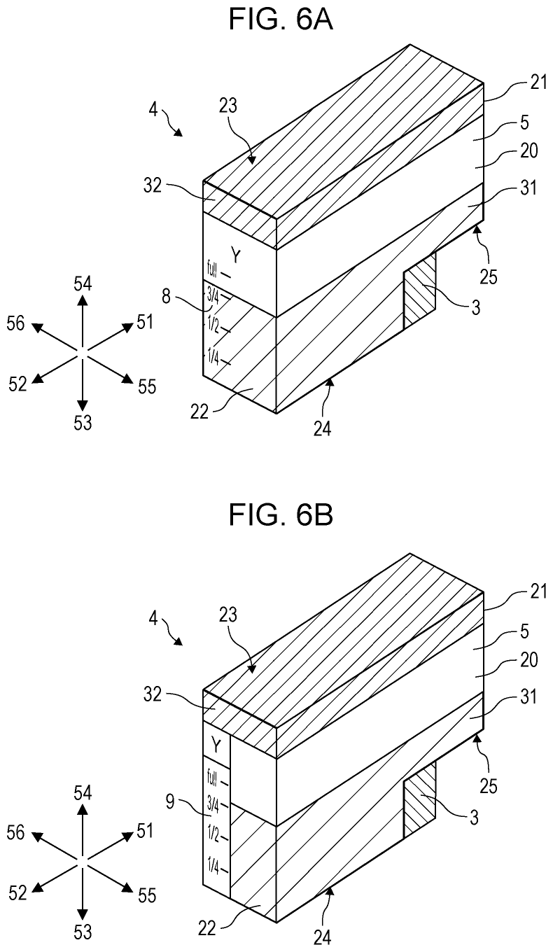

FIGS. 6A and 6b illustrate an ink cartridge 4. The basic configuration of the ink cartridge 4 shown in FIG. 6A is the same as that illustrated in FIG. 2A. However, the front wall 21 of the ink cartridge 4 is marked with a graded scale 8. This graded scale 8 can be seen from the outside of the ink-jet printing apparatus 1 through the cover (the window of the cover), described above. Even when the ink cartridge 4 has the graded scale 8, the user can easily determine the amount of ink contained in the ink cartridge 4 through the cover of the ink-cartridge mounting unit 101. As shown in FIG. 6B, the front wall 21 of the ink cartridge 4 may have a label 9 with a graded scale. Alternative configurations may be employed in which such a graded scale and the graded scale provided on the window shown in FIGS. 5A and 5B can be seen from the outside of the ink-jet printing apparatus 1 so that the user can determine the amount of ink contained in the ink cartridge 4 using these graded scales.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-011246 filed Jan. 27, 2020, which is hereby incorporated by reference herein in its entirety.

What is claimed is:

1. An ink-jet printing apparatus comprising:
an ink-cartridge mounting unit to which an ink cartridge containing ink is to be mounted,
wherein the ink-cartridge mounting unit includes a cover,
wherein the ink cartridge is disposed inside the cover and in the ink-jet printing apparatus in such a way that the ink cartridge is mounted to the ink-cartridge mounting unit, and then the cover is closed from an open state, and
wherein the ink contained in the ink cartridge can be seen from outside of the ink-jet printing apparatus in a state where the cover is closed.

2. The ink-jet printing apparatus according to claim 1, wherein, in the state where the cover is closed, the ink contained in the ink cartridge can be seen from the outside of the ink-jet printing apparatus through a window that is a partially cut-out portion of the cover.

3. The ink-jet printing apparatus according to claim 2, wherein the window is a hollow space through which the ink cartridge is exposed.

4. The ink-jet printing apparatus according to claim 2, wherein the window is a transparent window through which the ink contained in the ink cartridge can be seen from the outside of the ink-jet printing apparatus.

5. The ink-jet printing apparatus according to claim 1, wherein the cover is configured to be opened and closed by rotation.

6. The ink-jet printing apparatus according to claim 1, wherein the cover displays a graded scale.

7. The ink-jet printing apparatus according to claim 6,
wherein the cover includes a window that is a partly cut-out portion and is made of a transparent member, and
wherein the graded scale is located on the window made of the transparent member.

8. The ink-jet printing apparatus according to claim 6, wherein a label with an identification symbol corresponding to the graded scale is attached to the cover.

9. The ink-jet printing apparatus according to claim 6, wherein the ink cartridge is marked with a graded scale, and the graded scale located on the ink cartridge can be seen from the outside of the ink-jet printing apparatus.

10. The ink-jet printing apparatus according to claim 1,
wherein the ink cartridge has a front wall positioned forward when mounted to the ink-cartridge mounting unit and a back wall positioned at a position opposite to the front wall, and
wherein the back wall is made of a transparent wall through which the ink contained in the ink cartridge can be seen from the outside of the ink-jet printing apparatus.
